(19) United States
(12) Patent Application Publication
(10) Pub. No.: US 2007/0256747 A1
(43) Pub. Date: Nov. 8, 2007

(54) Motor driven valve

(75) Inventor: John M. Morris, Auburn, WA (US)

Correspondence Address: THE OLLILA LAW GROUP LLC, 2060 BROADWAY, SUITE 300, BOULDER, CO, 80302, US

(73) Assignee: GT Development, Seattle, WA (US)

(21) Appl. No.: 11/429,924

(22) Filed: May 8, 2006

(51) Int. Cl. F15B 13/044

(52) U.S. Cl. 137/625.65

(57) ABSTRACT

Embodiments of the motor driven valve 100 are suitable for selectively allowing or restricting fluid flow through a cavity, orifice, passageway, etc. Generally described, the motor driven valve 100 includes a motor 120, a pintle valve 140 drivenly connected to the motor 120 through a transmission assembly 160, and a casing 102 that houses at least one of the aforementioned components of the motor driven valve 100.

### FIELD OF THE INVENTION

Embodiments of the present disclosure relate generally to valves for pneumatic systems, and more particularly, to motor driven valves for pneumatic systems.

### BACKGROUND OF THE INVENTION

Pneumatic valves are commonly used in today's industrialized society. Typically, pneumatic valves are used to restrict fluid flow through a cavity, orifice, passageway, etc.

Often, pneumatic valves are operated by actuation of a solenoid. Although solenoids are convenient and well tailored to provide linear movement for reciprocating pneumatic valves, solenoids are not without their problems. For instance, solenoids are expensive and result in relatively expensive pneumatic valving systems. Therefore, although solenoid operated pneumatic valves are effective at restricting fluid flow through a cavity, orifice, passageway, etc., there exists a need for a more economical solution for achieving the same or similar result. Especially in situations requiring a larger orifice where speed of actuation is not critical.

### SUMMARY OF THE INVENTION

A motor driven valve constructed in accordance with one embodiment of the present disclosure includes a casing having a valve bore and a valve slidably disposed in the valve bore. The valve is translatable from a first position to a second position. The motor driven valve also includes an inlet and an outlet interconnected by a cavity through which fluid may pass, and an electric motor for affecting movement of the valve from the first position to the second position.

### BRIEF DESCRIPTION OF THE DRAWINGS

The foregoing aspects and many of the attendant advantages of this invention will become more readily appreciated by reference to the following detailed description, when taken in conjunction with the accompanying drawings, wherein:

FIG. 1 is a perspective view of one embodiment of a two-way motor driven valve constructed in accordance with aspects of the present invention;

FIG. 2 is an exploded view of the motor driven valve shown in FIG. 1;

FIG. 3 is a longitudinal cross-sectional view of the motor driven valve of FIG. 1 shown in a valve closed position;

FIG. 4 is a longitudinal cross-sectional view of the motor driven valve of FIG. 1 shown in a valve open position; and

FIG. 5 is a longitudinal cross-sectional view of another embodiment of a motor driven valve illustrating a three-way valve configuration.

### DETAILED DESCRIPTION OF EXEMPLARY EMBODIMENTS

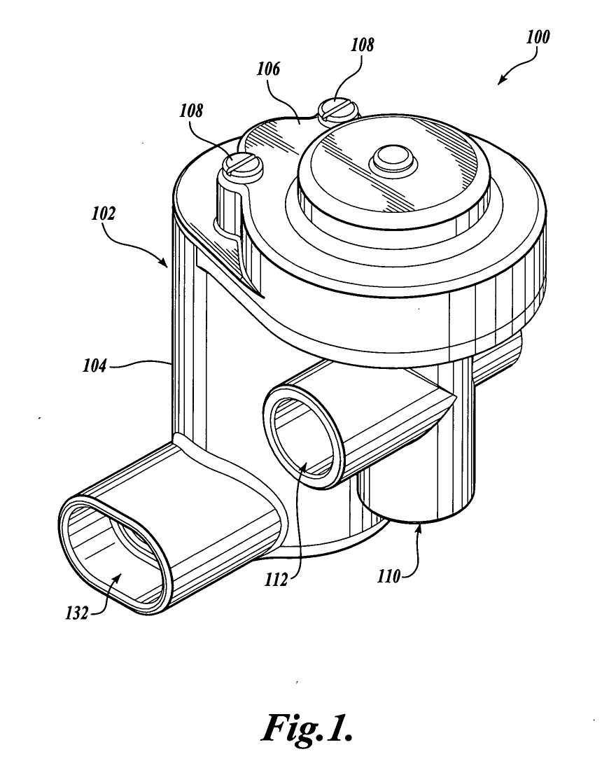

FIGS. 1-4 illustrate one exemplary embodiment of a motor driven valve 100 constructed in accordance with aspects of the present disclosure. The motor driven valve 100 is suitable for selectively allowing or restricting fluid flow through a cavity, orifice, passageway, etc. The valve open position refers to a valve position which allows fluid flow through a cavity, orifice, passageway, etc., while the valve closed position refers to a valve position which substantially restricts fluid flow through the same. The motor driven valve 100 includes a motor 120, a pintle valve 140 drivenly connected to the motor 120 through a transmission assembly 160, and a casing 102 that houses at least one of the aforementioned components of the motor driven valve 100.

The casing 102 includes a main body portion 104 and an optional closure portion 106 removably connected to the motor 120 by suitable mechanical fasteners 108. The casing 102 is suitably formed of metal, thus creating a rigid and rugged housing for the internal components of the motor driven valve 100. However, it is contemplated that other materials, such as composite plastics or the like, may be utilized.

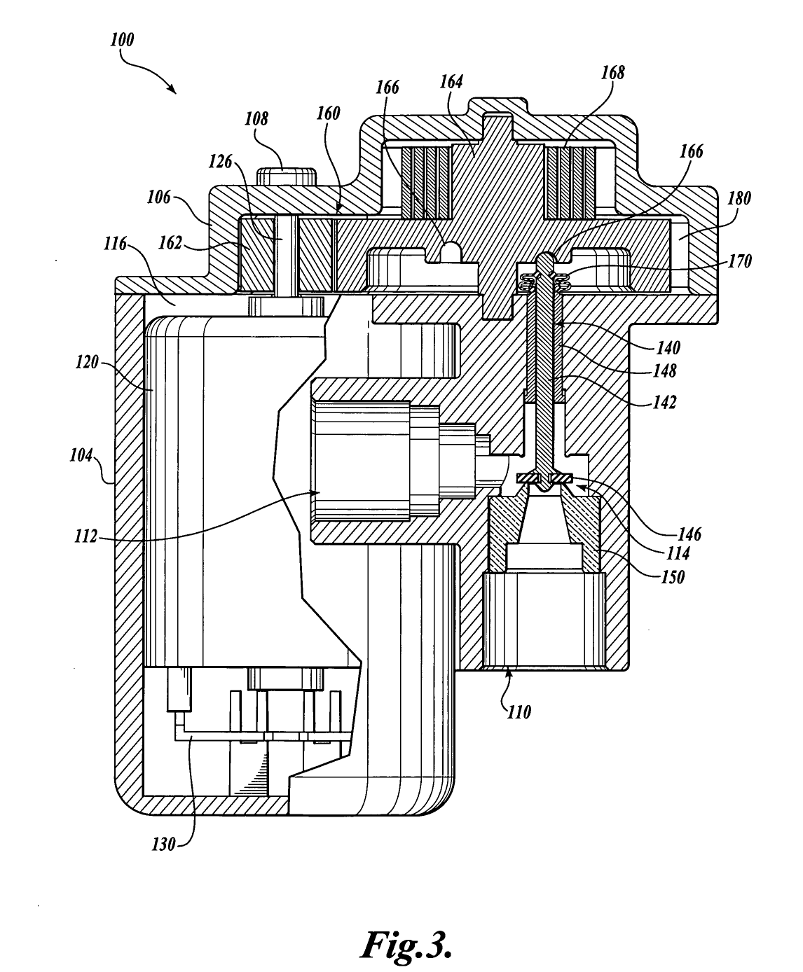

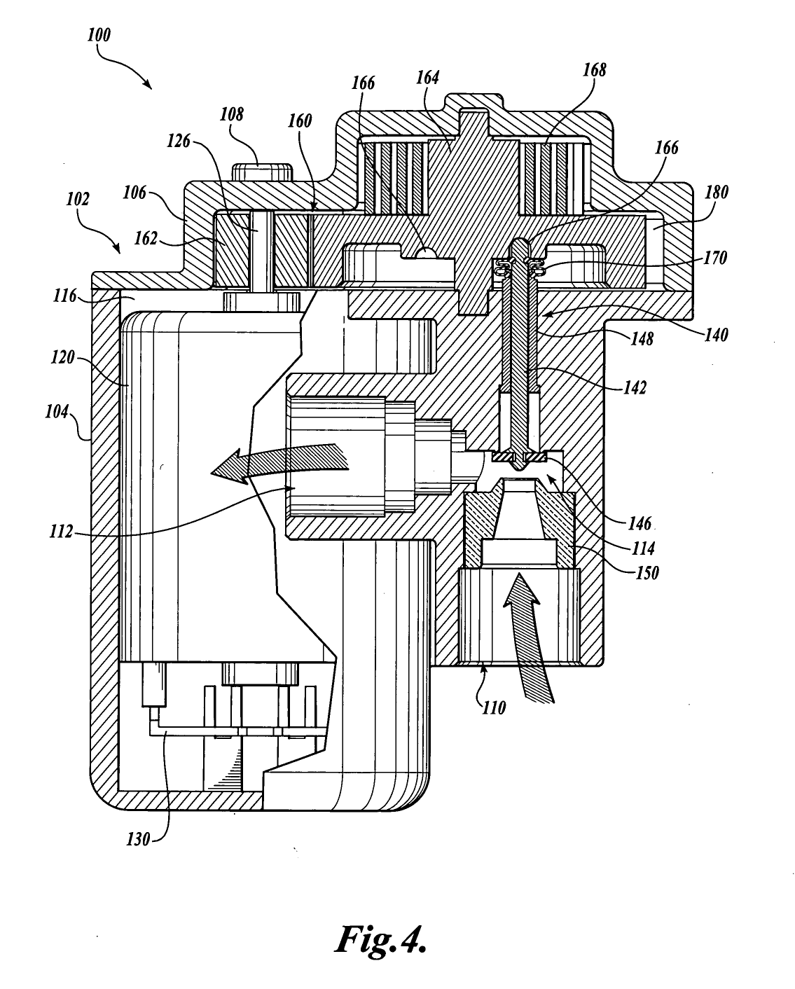

In the embodiment shown, the casing 102 defines a fluid inlet 110 and a fluid outlet 112 interconnected by a cavity 114 (see FIGS. 3 and 4). The casing 102 also includes suitable mounting structure (not shown), such as brackets, for allowing the motor driven valve 100 to be securely attached to a desired surface, such as a chassis of a motor vehicle.

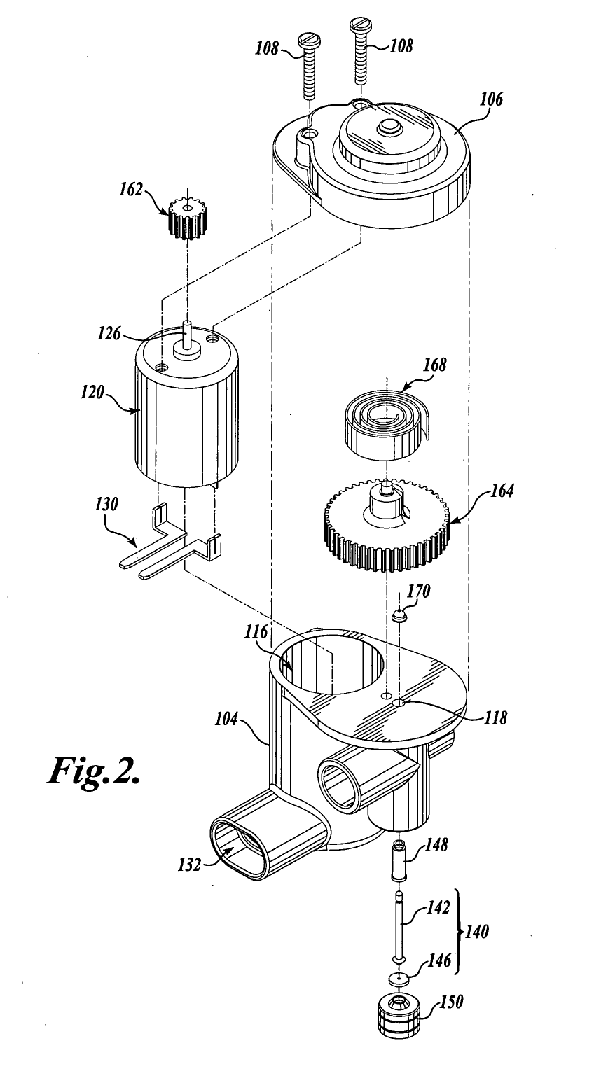

As best shown in FIGS. 2-4, the main body portion 104 defines a motor cavity 116. The motor cavity 116 may be generally cylindrically shaped and suitably sized for receiving the motor 120 in a secure and supported manner. While the motor cavity 116 provides for the motor 120 to be disposed within the casing 102, it will be appreciated that in alternative embodiments, the motor 120 may attach to the exterior of the casing 102 in a secured and supported manner or supported independently of the casing, and yet still provide the functionality as described below.

The main body portion 104 further defines a pintle bore 118 disposed in parallel with the motor cavity 116. The pintle bore 118 extends from an upper surface of the main body portion 104 to the cavity 114 and is dimensioned to receive the pintle 142 of the pintle valve 140 in a slidably supporting manner, as will be described in more detail below.

In one embodiment, the motor 120 is a conventional brush or brushless, DC motor with a single rotational output shaft 126. However, any electrical motor, including either AC or DC having a rotational output shaft, may be utilized while remaining within the spirit and scope of the present disclosure.

The output shaft 126 of the motor 120 projects outwardly from the top of the main body portion 104. Contacts 130 are located at the opposite end of the motor 120 and are adapted to be connected to a power source. For example, the contacts 130 may be attached to a switch (not shown) in connection with a vehicle 12-volt battery terminal (not shown) in order to supply the motor 120 with appropriate power required to rotate the output shaft 126. The main body portion 104 of the casing 102 includes a contact aperture 132 near the contact end of the motor 120 to allow the contacts 130 to be connected to an external switch or battery, if desired.

Still referring to FIGS. 2-4, the pintle valve 140 will now be described in greater detail. The pintle valve 140 includes a pintle 142 and a poppet 146. When assembled, the pintle 142 is slidably disposed in a supporting manner within the pintle bore 118 and is oriented substantially parallel with the output shaft 126 of the motor 120. In one embodiment, a pintle guide 148 may be disposed within the pintle bore 118. The pintle guide 148 allows the pintle 142 to slidably reciprocate between the valve closed and valve opened positions in a guided manner.

In either embodiment, one end of the pintle 142 projects outwardly from the top of the main body portion 104 and mechanically engages with the transmission assembly 160, as described in more detail below. The opposite end of the pintle 142, to which the poppet 146 is mounted, is positioned within the cavity 114. The poppet 146 is configured to restrict fluid flow through the cavity 114 between the fluid inlet 110 and the fluid outlet 112 when placed in the proper position. In one embodiment, the poppet 146 is formed from a flexible material for improving its seal forming capabilities when contacting, for example, the opposing ends of the cavity 114.

In use, the poppet 146 reciprocates with the pintle 142 in order to create a valving function within the cavity 114, thus either permitting or restricting fluid flow communication between the fluid inlet 110 and the fluid outlet 112. In one embodiment, the poppet 146 is positioned to seal the fluid inlet 110 when the pintle valve 140 is in the closed position, as shown in FIG. 3. Conversely, the poppet 146 may be positioned to seal the upper seat in cavity 114 (FIG. 4), thus allowing fluid flow therethrough. As such, the pintle valve 140 reciprocates between a valve closed and a valve opened position, as best shown in FIGS. 3 and 4, respectively.

In one embodiment, a poppet seat 150 is provided for interaction with the poppet 146. The poppet seat 150 defines an aperture through its center for permitting fluid flow therethrough when the valve 140 is in the valve open position. The poppet seat 150 is suitably disposed in the fluid inlet 110 adjacent the cavity 114 and in alignment with the poppet 146.

In the valve closed position, the poppet 146 and the poppet seat 150 create a seal which substantially restricts the fluid flow from the fluid inlet 110 to the fluid outlet 112. In one embodiment, the poppet seat 150 has a lip on the surface which mates with the poppet 146 in the valve closed position in order to create a more effective seal with the poppet. The poppet seat 150 may be formed using any non-corrosive material which enables the poppet 146 to form a tight seal around the perimeter of the poppet seat 150.

As may be best seen by referring to FIGS. 2-4, one suitable embodiment of a transmission assembly 160 for transmitting rotational movement of the output shaft 126 of the motor 120 into reciprocating movement of the pintle valve 140 is illustrated. The transmission assembly 160 includes a drive gear 162 and a driven gear 164. The drive gear 162 is fixedly coupled in a coaxial manner to the output shaft 126 of the motor 120.

The drive gear 162 is mechanically coupled in a conventional manner to the driven gear 164, which is journaled for rotation on the main body portion 104. As such, the drive gear 162 provides rotational force to the driven gear 164 when the motor 120 is activated, thereby causing the driven gear 164 to rotate in a preselected direction from a first or starting position to a second or end position, as will be described in more detail below.

As best represented in FIGS. 3 and 4, the driven gear 164 includes a cam 166 on one side surface and is suitably formed by a helical groove in the driven gear 164. When assembled, one end of the pintle valve 140 extends into the groove of the cam 166 to selectively reciprocate the pintle valve 140 into and out of sealing engagement with the poppet seat 150.

The cam 166 has a substantially consistent radial location with respect to the rotation axis of the driven gear 164. This allows the pintle valve 140, in its slidably mounted position perpendicular to the driven gear, to remain in contact with the cam 166 as the driven gear 164 rotates. As such, the end of the pintle valve 140 acts as a cam follower as the driven gear 164 is rotated and affects movement on the pintle valve 140.

In one embodiment, the cam 166 continues substantially around the driven gear 164, creating an arc slightly less than 360°. Alternatively, the cam 166 may form an arc which is only partially disposed around the driven gear 164, thus requiring the driven gear 164 to rotate fewer degrees to complete the cam's helical groove.

During operation of the motor driven valve 100, it may be desirable for the end of the pintle 142 to be in continuous contact with the cam 166. To that end, the pintle 142 may be biased against the cam 166 by a biasing device, such as a spring (not shown). The pintle valve 140 includes a pintle seal 170, which restricts fluid from entering the cavity 180.

The pintle seal 170 defines an aperture suitable dimensioned to facilitate the insertion of the pintle 142. The end of the pintle seal 170 adjacent to the cam 166 is coupled to the end region of pintle 142. The pintle seal 170 may be coupled to an annular groove formed on the pintle 142, whereby the pintle seal 170 is frictionally constrained to the pintle 142. Alternatively, the pintle seal 170 may be secured in a position relative to the pintle 142 by a collar on the pintle 142. The other end of the pintle seal 170 connected to the pintle guide 148 in a suitable groove. The pintle seal 110 may also include a bellows to facilitate elongation with minimal force.

In operation, the pintle seal 170 permits the pintle valve 140 to reciprocate between the valve closed and opened positions. Biasing members may be utilized to bias the pintle 142 against the cam 166 in order to maintain continuous contact between them, such as a coil spring, leaf spring, or the like.

Prior to activation of the motor 120, the driven gear 164 is in a first or starting position. As such, the pintle 142 is in contact with the shallowest part of the cam's helical groove, as depicted in FIG. 3. After activation of the motor 120, the driven gear 164 is rotated to a second or end position where the motor stalls in an activated state and the pintle 142 is in contact with the deepest part of the cam's helical groove, as depicted in FIG. 4. Although the motor driven valve 100 is illustrated and described as a normally closed valve, it should be apparent that other configurations, such as a normally opened valve, are also within the scope of the present disclosure.

It will be appreciated that the stroke of the pintle valve 140 is the difference in the depth of the cam's groove in the activated and unactivated states and is substantially equal to the vertical displacement of the pintle 142. In one embodiment, the helical arrangement of the cam 166 provides a substantially constant slope. However, varying slopes may be beneficial to change the engagement speed of the pintle valve 140 when opening or closing the valve. In an alternative embodiment, the cam 166 may be a protruding structure from the bottom surface of the driven gear 164 rather than a groove. It will be appreciated that the protruding cam has the same helical configuration as the groove cam.

In alternative embodiments of the present disclosure, the transmission assembly may assume a plurality of different configurations in order to transmit the rotary motion of the output shaft 126 of the motor 120 into linear motion of the pintle valve 140. For example, the transmission assembly may be a piston which includes an arm linked to a rotary wheel coupled to the drive shaft of the motor, creating reciprocating motion. In another embodiment, the drive shaft of the motor may be directly coupled to a cam which translates the pintle valve in a linear manner.

In a further embodiment, a rack and pinion mechanism may be utilized to convert rotary motion of the motor to linear motion of the pintle valve. In such a configuration, a drive gear containing a plurality of teeth is coupled to the motor and acts as the pinion. A rack is in mechanical communication with the pinion by the meshing of teeth interacting with each other, providing reciprocating motion to the pintle valve. Alternatively, the pintle may be integrated with the rack in order to reduce parts and linkages. It will be appreciated that other transmission assemblies may be utilized to convert rotary motion into linear motion, such as a lead screw, while remaining within the scope and spirit of the present disclosure.

As earlier described, the driven gear 164 of the transmission assembly 160 attains first and second positions during the operation of the motor driven valve 100. In embodiments that utilize a unidirectional electric motor, it may be advantageous for one of the gears of the transmission assembly 160 to be biased against rotation when the motor 120 is activated. Therefore, in certain embodiments, the motor driven valve 100 includes a biasing device 168, such as a torsion spring, functionally connected to the driven gear 164 of the transmission assembly 140.

In use, when the motor 120 rotates the drive gear 162, the drive gear 162 in turn drives the driven gear 164 from the first position to the second position against the biasing action of the biasing device 168, thereby storing energy therein. When the motor 120 is deactivated, the biasing device 168, in this case, the torsion spring, unwinds, releasing the stored energy, and rotating the driven gear 164 back to the first position. As was described briefly above, the motor 120 affects movement of the pintle valve 140 from a valve closed position to a valve opened position, or vice versa, via a transmission assembly 160.

While the biasing device 168 is shown as a torsion spring, it is contemplated that other biasing means may be used to bias one or more components of the transmission assembly 160 into the first position without departing from the spirit and scope of the present disclosure. Additionally, while the driven gear 164 is shown biased against rotation, it will be appreciated that either the drive gear 162 or the driven gear 164 or both can be biased against rotation.

In some embodiments, it is desirable to utilize a biasing device 168 which will not overcome the motor 120 when the motor 120 is in the activated state, preventing the driven gear 164 from rotating fully to the second position. Therefore, the spring constant (K) of the biasing member should be selected so as to allow the motor 120 to overcome the biasing device, permitting full rotation of the driven gear 164 as necessary to complete the cam's helical curve. Conversely, the spring constant (K) should be selected so as to overcome friction resulting from the gears and motor so that the driven gear 164 may return to its first position when the motor 120 is deactivated.

Although several embodiments of the present disclosure include a biasing device 168 to return the driven gear 164 to the first position when the motor 120 is returned to a non-activated state, the absence of such a component does not depart from the present disclosure. Further, a reversible motor may be used. In such an example, the motor 120 may be activated in a first state to close the valve and then activated in a second state to open the valve. The first and second states may be achieved by reversing the contact wires utilizing a switching mechanism or be internally controlled by the reversible motor.

Operation of the motor driven valve 100 between the valve closed position and the valve opened position may be best understood by referring to FIGS. 3 and 4. In the valve open position, the poppet 146 is in an open position in the cavity 114, thereby allowing continuous fluid flow between the fluid inlet 110 and fluid outlet 112. The pintle seal 170 is in its non-deformed position and the motor 120 is in the activated state. Still referring to the valve open position, the pintle 142 is seated within the deepest groove portion of the cam 166.

In order to close the motor driven valve 100 and thus substantially restrict fluid flow between the fluid inlet 110 to the fluid outlet 112, the motor 120 is deactivated. When deactivated, the biasing device 168 unwinds to rotate the driven gear 164, thereby releasing stored energy in the biasing member 168. As the driven gear 164 rotates, the pintle 142 traces the helical groove of the cam 166 from the deepest groove portion to the shallowest groove portion, slidably displacing the pintle 142 through the pintle bore 118, and thus translating the poppet 146 from the valve open position depicted in FIG. 4 to the normally closed valve position of FIG. 3.

As the pintle 142 traces along the helical groove on the cam 166, the pintle 142 reaches the end of the stroke where the poppet 146 is forced against the poppet seat 150, sealing the poppet seat aperture. In this position, the fluid inlet 110 is closed by the poppet 146 and fluid flow through the cavity 114 is substantially restricted. At substantially the same instant, the driven gear 164 and drive gear 162 stop rotating.

To return the motor driven valve 100 to the valve open position shown in FIG. 4, the motor 120 is switched from a deactivated state to an activated state. This action rotates the driven gear 164 against the biasing action of the biasing device 168, illustrated as a torsion spring, and stores energy in the biasing device 168. As the driven gear 164 rotates back to the first position, fluid pressure or a biasing device (not shown) forces the pintle 142 into continuous contact with the cam 166. As such, the pintle 142 traces the helical groove of the cam 166 from the shallower cam groove position to the deeper cam groove position as the driven gear 164 rotates via the motor 120.

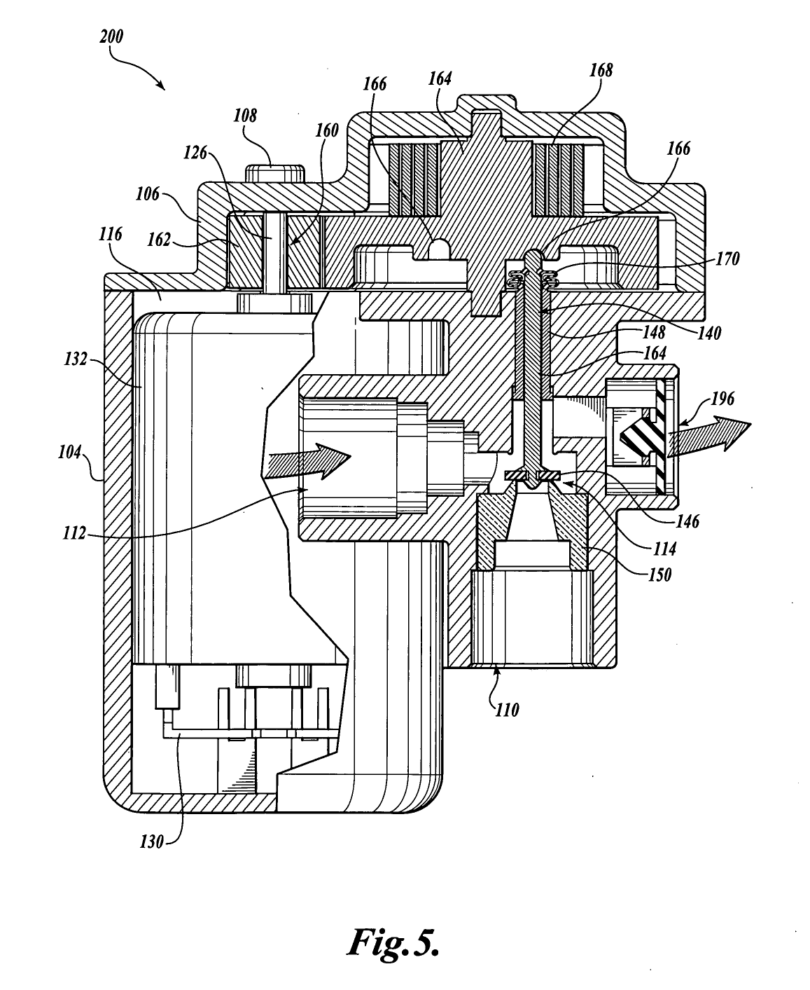

As the pintle 142 slidably translates, the poppet 146 disengages from the poppet seat 150, thus permitting fluid flow from the fluid inlet 110 to the fluid outlet 112. In this position, the poppet 146 is completely disengaged from the poppet seat 150, and thus, the motor driven valve 100 is in the valve open position. Fluid pressure forces the poppet 146 against the upper seat to seal the exhaust port (FIG. 5).

Regarding the operation of the motor driven valve 100, the cycles may be altered to facilitate the same means of opening and closing a valve by actuating a motor, while still remaining within the sprit and scope of the present disclosure. For example, the activation of the motor may result in the driven gear moving the pintle 142 into a closed position. As a result, such embodiments are also within the scope of the present disclosure.

FIG. 5 illustrates another embodiment of a motor driven valve 200 constructed in accordance with aspects of the present disclosure. The motor driven valve 200 is substantially similar in materials, constructions, and operation as the motor driven valve 100, with the following exceptions. As best shown in FIG. 5, the main body portion further defines an exhaust outlet 196 connected in fluid communication with the cavity 114. As such, the motor driven valve 200 is configured such that fluid from fluid outlet 112 may be permitted to be exhausted outside the casing 102 through the exhaust outlet 196 when the pintle valve 140, and thus, the poppet, is in the closed position.

Preferably, the poppet 146 will seal the entrance to the exhaust outlet 196 when the motor driven valve 100 is in the valve open position, as depicted in FIG. 4, preventing fluid from flowing outside the casing 102 when the motor driven valve 100 is in the valve open position, thus only directing fluid between the fluid inlet 110 and the fluid outlet 112.

The exhaust outlet 196 may be equipped with a restricting mechanism, such as a one way valve, that restricts fluid flow to a single direction outward of the cavity 114 through the exhaust outlet 196, thus prohibiting foreign fluids or contaminates from entering the motor driven valve 100 through the exhaust outlet 196.

While several exemplary embodiments of the invention have been illustrated and described, it will be appreciated that various changes can be made therein without departing from the spirit and scope of the invention. For example, while the casing has been depicted as defining the inlet, outlet, and the cavity, it will be appreciated that such structure may be independent of the casing.

1. An apparatus, comprising:
a casing having a valve bore;
a valve slidably disposed in the valve bore, the valve being translatable from a first position to a second position;
an inlet and an outlet interconnected via a cavity through which fluid may pass; and
an electric motor for affecting movement of the valve from the first position to the second position.

2. The apparatus of claim 1, further comprising a transmission interconnecting the motor and the valve for transmitting motion generated by the motor into motion of the valve.

3. The apparatus of claim 2, wherein the transmission includes a drive gear fixedly attached to the drive shaft and a driven gear contacting the valve, the drive gear being mechanically coupled to the driven gear for rotation thereof.

4. The apparatus of claim 3, wherein the driven gear has a helical cam that interacts with the valve for translation thereof.

5. The apparatus of claim 2, further comprising a biasing device, wherein the transmission moves from a first position to a second position against the biasing action of the biasing device when the electric motor is activated, the biasing device returning the transmission into the first position when the motor is deactivated.

6. The apparatus of claim 2, wherein the valve includes a biasing member to maintain continuous contact with the transmission.

7. The apparatus of claim 1, wherein the valve is translatable from the first position to the second position to restrict fluid flow through the cavity via activation of the electric motor.

8. The apparatus of claim 1, wherein the electric motor is selected from a group consisting of a DC motor, an AC motor, a brush motor, a brushless motor, and a uni-directional motor.

9. The apparatus of claim 1, wherein the first position of the valve is a valve open position and the second position of the valve is a valve closed position, and wherein the apparatus further comprises an exhaust outlet in fluid communication with the cavity, the exhaust outlet permitting fluid flow external of the casing when the valve is not in the valve open position.

10. A motor driven valve, comprising:
a casing defining a valve bore;
an electric motor supported by the casing, the electric motor including a rotational drive shaft;
an inlet and an outlet interconnected via a cavity through which fluid may pass;
a valve slidably disposed in the valve bore, the valve being translatable between a first position and a second position; and
a transmission interconnecting the motor and the valve for transmitting rotational motion of the drive shaft to linear motion of the valve.

11. The motor driven valve of claim 10, wherein the valve includes a biasing member to maintain continuous contact with the transmission.

12. The motor driven valve of claim 10, wherein the valve bore includes a valve seal restricting fluid flow through the valve bore.

13. The motor driven valve of claim 10, wherein the electric motor is selected from a group consisting of a DC motor, an AC motor, a brush motor, a brushless motor, and a uni-directional motor.

14. The motor driven valve of claim 10, wherein the transmission includes a drive gear fixedly attached to the drive shaft and a driven gear contacting the valve, the drive gear being mechanically coupled to the driven gear for rotation thereof.

15. The motor driven valve of claim 14, wherein the driven gear includes a cam that interacts with the valve for translation thereof.

16. The motor driven valve of claim 14, wherein the drive gear or the driven gear of the transmission moves from a first position to a second position upon activation of the electric motor, the transmission including a biasing device that biases either the drive gear or the driven gear of the transmission into the first position when the electric motor is deactivated.

17. The motor driven valve of claim 10, wherein the first position of the valve is a valve open position and the second position of the valve is a valve closed position, and wherein the apparatus further comprises an exhaust outlet in fluid communication with the cavity, the exhaust outlet permitting fluid flow external of the casing when the valve is not in the valve open position.

18. A motor driven valve, comprising:
a casing defining a pintle bore, an inlet, an outlet, and a cavity that interconnects the inlet and outlet in fluid communication, the pintle bore being in fluid communication with the cavity;
a unidirectional electric motor supported by the casing, the electric motor having a rotational drive shaft;
a pintle valve slidably disposed in the pintle bore, wherein a portion of the pintle valve translates between a valve open position and a valve close position within the cavity;
a transmission interconnecting the electric motor and the pintle valve for transmitting the rotational motion of the drive shaft to linear motion of the pintle valve, wherein activation of the electric motor causes the transmission to operate from a first position to a second position; and
a biasing device functionally coupled to the transmission for returning the transmission to the first position when the motor is deactivated.

19. The motor driven valve of claim 18, wherein the biasing device is a torsion spring.

20. The motor driven valve of claim 18, wherein the output shaft of the electric motor is substantially parallel with the pintle valve.
